(19) United States
(12) Patent Application Publication
(10) Pub. No.: US 2025/0355628 A1
(43) Pub. Date: Nov. 20, 2025

(54) STOCHASTIC COMPUTING LOW-DISCREPANCY SEQUENCE GENERATOR AND METHOD FOR USE OF SAME

(71) Applicant: UNIVERSITY OF LOUISIANA LAFAYETTE, Lafayette, LA (US)

(72) Inventors: Mohammadhassan Najafi, Lafayette, LA (US); Mehran Shoushtari Moghadam, Lafayette, LA (US); Sercan Aygun, Lafayette, LA (US); Mohsen Riah Alam, Lafayette, LA (US)

(73) Assignee: UNIVERSITY OF LOUISIANA LAFAYETTE, Lafayette, LA (US)

(21) Appl. No.: 19/213,817

(22) Filed: May 20, 2025

Related U.S. Application Data
(60) Provisional application No. 63/649,930, filed on May 20, 2024.

(51) Int. Cl. G06F 7/58; G06F 5/01; G06F 7/50

(52) U.S. Cl. CPC G06F 7/582; G06F 5/01; G06F 7/50

(57) ABSTRACT

A random number generator for accurate and energy-efficient stochastic computing, providing a low-cost and energy-efficient Low-discrepancy Sequence Generator derived from Powers-of-2 Van der Corput (VDC) sequences.

### CROSS-REFERENCE TO RELATED APPLICATIONS

This application claims priority to U.S. Provisional Application No. 63/649,930, filed on May 20, 2024, titled “Stochastic Computing Low-Discrepancy Sequence Generator.”

### STATEMENT REGARDING FEDERALLY SPONSORED RESEARCH OR DEVELOPMENT

This work was funded in party by grants #2019511 and #2339701 from the National Science Foundation.

### Reference to a “Sequence Listing,” a Table, or a Computer Program

Not applicable.

### FIELD OF THE INVENTION

The field of the invention is stochastic computing, namely generating sequences for use in stochastic computing.

### BRIEF DESCRIPTION OF THE DRAWINGS

The drawings constitute a part of this specification and include exemplary embodiments of the invention disclosed herein, which may be embodied in various forms. It is to be understood that in some instances, various aspects of the invention may be shown exaggerated or enlarged to facilitate an understanding of the invention. Therefore, the drawings may not be to scale.

FIG. 1 is a logic diagram of the architecture of a stochastic number generator (SNG) as known in the art.

FIG. 2 is a table comparing the mean absolute error of different random sequences when multiplying two 8-bit precision stochastic bit-streams with different bit-streams lengths. The evaluation was conducted for 8-bit precision input data, and accurate multiplication results were obtained after 2^{2×8} operation cycles. The assessment was performed for operation cycles ranging from 2⁶ to 2¹⁶, corresponding to bit-stream lengths varying from 2⁶ to 2¹⁶.

FIG. 3A is a line graph showing the mean absolute error of stochastic computing multiplication on two 8-bit precision input comparing different random sequences.

FIG. 3B is a line graph showing the mean absolute error of stochastic computing scaled addition on two 8-bit precision input comparing different random sequences.

FIG. 4 is a table comparing the mean absolute error of the two 8-bit precision input bit-streams for stochastic computing scaled addition with different bit-stream lengths.

FIG. 5A shows a Halton sequence generator known in the context of random number generators.

FIG. 5B shows a Sobol sequence generator known in the context of random number generators.

FIG. 5C shows the disclosed P2LSG design for an embodiment with base-16 (P2LSG-16). Unlike the generators shown in FIGS. 5A and 5B, the disclosed design utilizes only toggle flip-flops and hardwiring.

FIG. 6A provides the disclosed P2LSG method to hard-wiring bits for reversing operation (e.g. significance inversion).

FIG. 6B provides an example for the 8-bit counter to generate P2LSG-2, P2LSG-4, P2LSG-8, and P2LSG-16 sequences, with up to P2LSG-256 possible.

FIG. 7 provides a table of the hardware cost comparison for different number generators generating two different 8-bit random sequences.

FIG. 8A provides the P2LSG method to assign parallel indexing bits.

FIG. 8B provides a P2LSG-16 example with PAR=4 concurrent sequence generations.

FIG. 9 provides the visual results of the SC image scaling using different SNGs (with P2LSG, Sobol, Niederreiter, or LFSR) and a 4-to-1 MUX.

FIG. 10 provides an example of stochastic computing-based video processing for scene merging. The foreground video with a blank background is embedded into a static jungle background picture. The figure shows several frames from the first 04.20 sec of the video in the test.

FIG. 11 provides a table comparing SC image scaling with different random sequences.

FIG. 12 provides a table of the hardware cost comparison of the image and video processing case studies performed. Energy and CPL are for producing each output pixel. The applied bit-stream length (N) is 256.

### BACKGROUND OF THE INVENTION

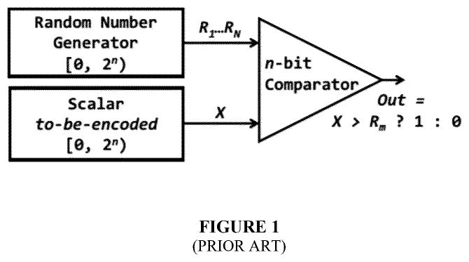

Stochastic computing (SC) is a re-emerging computing paradigm offering low-cost and noise-tolerant hardware designs for complex arithmetic operations. In contrast to traditional binary computing, which operates on positional binary radix numbers, SC designs process uniform bit-streams of ‘0’s and ‘1’s with no significant digits. While the paradigm was known for approximate computations for years, recent works showed deterministic and completely accurate computation using SC circuits. Encoding data from traditional binary to stochastic bit-streams is an important step in any SC system. The data are encoded by the probability of observing a ‘1’ in the bit-stream. For example, a bit-stream with 25% ‘1’s represents the data value of 0.25. The accuracy of the computations and the energy efficiency of the SC designs highly depend on this encoding step, particularly on the distribution of ‘1’s and ‘0’s in the bit-streams. A stochastic number generator (SNG), which encodes a data value in binary format to a stochastic bit-stream, consists of a random number generator (RNG) and a binary comparator. FIG. 1 shows the structure of an SNG commonly used in SC systems. At any cycle, the output of comparing the input data with the random number from the RNG unit produces one bit of the bit-stream. The distribution of the bits in the encoded bit-streams is directly affected and controlled by the RNG component of the SNG.

The choice of the RNG unit directly affects the distribution of the bits in stochastic bit-streams. While traditionally pseudo-random sequences, generated by linear-feedback shift registers (LFSRs), were used in the SNG unit, the state-of-the-art (SOTA) studies employ quasi-random sequences, such as Sobol (S) and Halton (HL) sequences, for high-quality generation of stochastic bit-streams. These sequences remove the random fluctuation error in generating bit-streams by producing Low-Discrepancy (LD) bit-streams. LD bit-streams quickly converge to the target value, reducing the length of bit-streams and, consequently, the latency of stochastic computations. This latency reduction directly translates to savings in energy consumption (i.e., power×latency), a critical metric in the hardware efficiency of SC systems. A challenge with the known SNGs using sequences like Sobol and Halton is the high hardware cost.

Random Sequences. Random sequences are widely used in various research domains, particularly in emerging computing technologies. Some sequences are binary-valued with logic-1s and logic-0s. These sequences possess the orthogonality property, that is, different random sequences are (approximately) uncorrelated. Some sequences, on the other hand, do not have binary values (having real values). Certain real-valued sequences have LD properties. The discrepancy term in LD refers to how much the sequence points deviate from uniformity. The recurrence property (i.e., the constructability of further-indexed sequences from the previous-indexed ones) in LD sequences is beneficial for cross-correlation, which is advantageous for SC systems that require uncorrelated bit-streams. Briefly reviewed herein are the following known sequences: Weyl, R, Latin Hypercube, VDC, Faure, Hammersley, Halton, Niederreiter, and Poisson Disk.

The Weyl sequence known in the art belongs to the class of additive recurrence sequences, characterized by their generation through iterating multiples of an irrational number modulo 1. Specifically, by considering α ∈ R as an irrational number and x_i ∈ {0, α, 2α, . . . , kα}, the sequence x_i-[x_i] (x_i modulo 1) produces an equidistributed sequence within the (0, 1) interval. Another example of an additive recurrence sequence is the R sequence, which is based on the Plastic Constant (the unique real solution of the cubic equation). The Latin Hypercube sequences involve partitioning the sampling space into equally sized intervals and randomly selecting a point within each interval.

The VDC sequence serves as the foundation for many LD sequences. It is constructed by reversing the digits of the numbers in a specific base, representing each integer value as a fraction within the [0, 1) interval. A VDC sequence in base-B is notated with VDC-B. As an example, the decimal value 11 in base-3 is represented by (102)₃. The corresponding value for the base-3 VDC is 2×3⁻¹+0×3⁻²+1×3⁻³=19/27.

Similarly, the Faure, Hammersley, and Halton sequences are derived from the VDC concept using prime or co-prime numbers. To generate the Faure sequence in q-dimensions, the smallest prime number p is selected such that p≥q. The first dimension of the Faure sequence corresponds to the VDC-p sequence, while the remaining dimensions involve permutations of the first dimension. The q-dimensional Halton sequence is generated by utilizing the VDC sequence with different prime bases starting from the first to the q-th prime number. The limitation of the Halton sequence is in utilizing prime number bases, which increases the complexity of the sequence generation.

The Hammersley sequence shares some similarities with the Halton sequence. For the sake of fair comparison with the Halton sequence, we adopt different bases for the Hammersley sequence in this work. The first Sobol sequence is the same as the VDC-2 sequence. The other Sobol sequences are generated through permutations of some sets of direction vectors. The Niederreiter sequence is another variant of the VDC sequence relying on the powers of some prime numbers. This sequence features irreducible and primitive polynomials that ensure LD and uniformity over the sample space. Finally, the Poisson Disk sequence generates evenly distributed numbers with minimal distance between them.

Stochastic Computing. SC has gained attention recently due to its intriguing advantages, such as robustness to noise, high parallelism, and low design cost. Complex arithmetic operations are realized with logic gates in SC. Significant savings in the implementation costs are achieved for different applications, from image processing to sorting and machine learning, to name a few. Data conversion is an essential step in SC systems. Input numbers must be converted to random bit-streams, where each bit has equal significance. SC supports real data in the unit interval, i.e., [0, 1]. A common coding format is unipolar encoding (UPE). In UPE, the probability of observing a ‘1’ in the bit-stream X, i.e., P(X=1), equals the input value or x. The common method for generating a bit-stream of size N is to compare the input number with N random numbers (R1 . . . RN). This is usually done serially in N clock cycles. A logic-1 is produced at the output if the input value is greater than the random number; A logic-0 is produced otherwise. The distribution of logic-1s in the produced bit-stream depends on the sequence of random numbers. When dealing with the signed values (x is in the range −1<x<1), a bipolar encoding (BPE) is used. In BPE, the probability that each bit in the bit-stream is ‘1’ is

$$P ( X = 1 ) = \frac{( x + 1 )}{2} .$$

SC operations consist of bit-wise logic operations. Multiplication of bit-streams in UPE is achieved by bit-wise AND, and in BPE by bit-wise XNOR operation. For accurate multiplication, the input bit-streams must be uncorrelated with each other. Performing bit-wise AND on correlated bit-streams with a maximum overlap in the position of ‘1’s gives the minimum of the input bit-streams. Scaled addition is realized in SC by a multiplexer (MUX) unit for both encodings. For scaled subtraction, a MUX with one inverter is utilized. The main inputs of the MUX can be correlated, but they should be uncorrelated with the select input bit-stream.

### SUMMARY OF THE INVENTION

This invention revolves around enhancing Stochastic Computing (SC) systems through developing an efficient Stochastic Number Generator (SNG) unit. The accuracy and energy efficiency of SC systems heavily rely on the SNG unit, which converts conventional binary data into stochastic bit-streams. Traditionally, SNG units have utilized pseudo-random sequences generated by linear-feedback shift registers (LFSRs). However, employing low-discrepancy (LD) sequences, such as Sobol and Halton sequences, can significantly enhance the efficiency of SC systems. Despite these improvements, the usage of many well-known random sequences for SC remains unexplored. This invention addresses this gap by introducing a novel Stochastic Number Generator (SNG) unit called P2LSG (Powers-of-2 Low-Discrepancy Sequence Generator). P2LSG is a lightweight and energy-efficient LD Sequence Generator derived from Powers-of-2 Van der Corput (VDC) sequences. In general, any VDC sequence number in an arbitrary base B can be obtained via reversing the corresponding digits of that number with respect to the radix point and demonstrating the new value in the (0,1) interval. This invention is implemented by incorporating a single log_2(D)-bit (D is the length of the bit-streams) counter and hardwiring scheme to obtain these specific Powers-of-2 bases. Furthermore, our invention can generate multiple and different sequence values simultaneously thanks to employing the parallel design of the P2LSG. The other strength point of our invention lies in deploying the P2LSG design for different configurations of the cascaded circuits where different levels of correlation are required. This generator aims to improve the accuracy and energy efficiency of SC systems while reducing hardware costs.

### DETAILED DESCRIPTION OF THE INVENTION

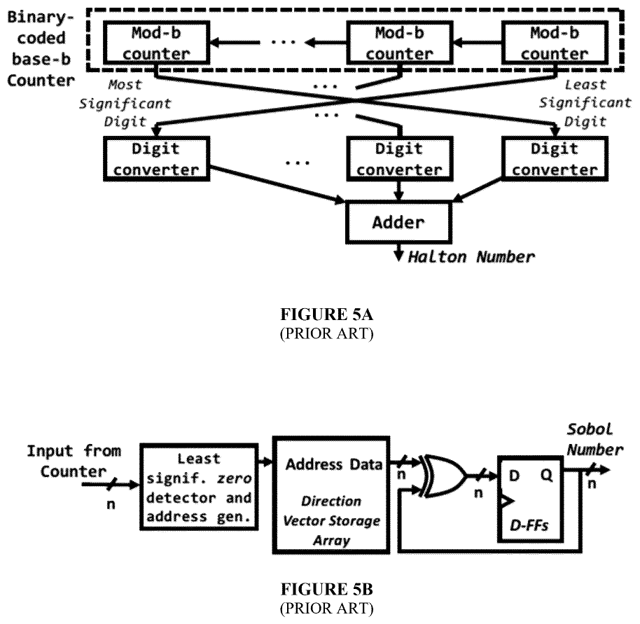

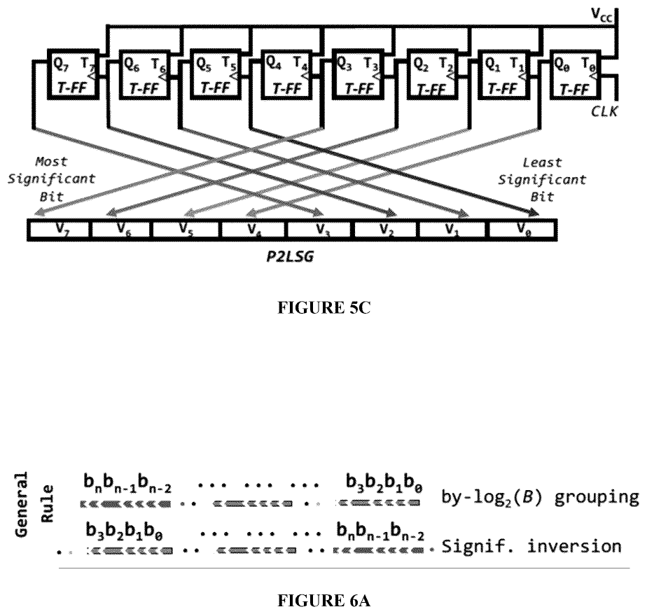

Proposed herein is a hardware implemented generator identified as a Powers-of-2 Low-Discrepancy Sequence Generator (“P2LSG”). FIG. 5A shows a previously proposed Halton generator known in the art, consisting of mod counters, digit converters, and an adder. In an additional existing generator, a Sobol sequence generator is based on some Direction Vectors (DVs). The DVs (V_x(x=0, 1, . . . , N−1)) are generated using some primitive polynomials and stored in a Direction Vector Array (DVA). By employing different DVs, different Sobol sequences are produced. In their design, a priority encoder finds the least significant zero (LSZ) in the output of a counter at any cycle. Depending on the position of the LSZ, a DV is selected from the DVA. The new Sobol number is recursively generated by XORing the respective DV and the previous Sobol number. FIG. 5B shows the design of this Sobol generator known in the art.

The disclosed P2LSG generator, shown in FIG. 5C provides a low-cost hardware design for efficient and lightweight generation of P2LSG sequences. The design uses a log₂(N)-bit counter for generating different sequences of Powers-of-2 bases up to N, where N may comprise the length of the bit-stream.

For a fair comparison with previous random generators and to assess the performance for various image processing applications, we target bit-streams of up to 256 (sufficient for representing 8-bit grayscale image data). Therefore, we require up to 256 different random numbers from the sequence generator to generate each bit-stream. The method to generate a base-B VDC sequence for the SNG unit consists of the following five steps:
[symbol] Generating an integer number.
[symbol] Converting the integer number to base-B representation.
[symbol] Reversing the base-B representation.
[symbol] Converting the base-B representation to a binary number.
[symbol] Scaling the input number within the [0, 1) interval to the corresponding 8-bit binary number in the [0, 256) range to be connected to the binary comparator.

The complexity of the hardware design for this algorithm is closely tied to the chosen base. The hardware designs are classified into two categories depending on the selected base: Class-I: those without Powers-of-2 bases, and Class-II: those with Powers-of-2 bases.

Class-I: Non-Powers-of-2 Base Generators. To implement this class of VDC sequence generators, combine the first two steps, [symbol] and [symbol] , by utilizing a base-B counter to generate the integer numbers in the corresponding base. For instance, a Binary Coded Decimal (BCD) counter can be employed for a base-10 representation. Step [symbol] is achieved by hard-wiring. Step [symbol] is implemented by employing adders and MUXs. Step [symbol] can be achieved by shift operations.

The Hammersley and Halton sequences extend the VDC sequence to higher dimensions, representing each dimension in a different prime base-B. Consequently, the hardware implementation of these sequences falls under the first class of sequence generator. The need for counters with prime radices and base conversion make the Halton sequence generator complex to implement in hardware. The hardware limitations of that design motivate us to explore the second class of generators for the Powers-of-2 bases.

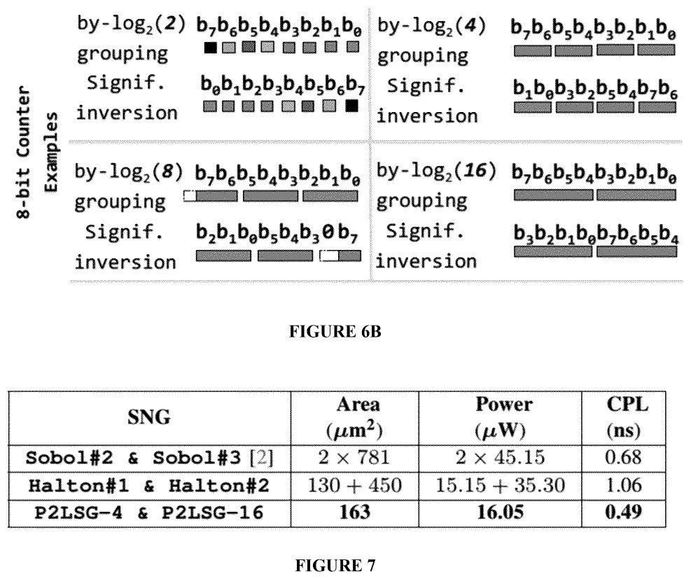

Class II: Powers-of-2 Base Generators. Sequential Design: To implement Powers-of-2 base generators, a binary counter with sufficient bits is utilized to represent the desired range of integer numbers in step [symbol] . To convert the value of a binary counter to its base-B representation (step [symbol] ), we consider groups of log₂(B) bits, starting from the least significant bit. If the last group lacks enough bits, some additional ‘0’ bits are appended via zero padding to ensure it forms a complete group. The reversing operation in step [symbol] is done by hard-wiring each group of bits, treating them as a single digit in base-B. The process of converting a base-B number to its equivalent binary representation is the inverse of step [symbol] . In this process, each group or base-B digit is considered as equivalent log_2(B) bits of binary representation and any exceeding bits beyond the counter in step [symbol] is discarded. FIG. 5C demonstrates an 8-bit precision P2LSG for base-16 (P2LSG-16). An Up-Counter counts up to 255, and the target sequence is obtained by significance inversion of each group; the least significant group becomes the most significant group, and vice versa. For this base-16 example, the output Q3 of the 4th T Flip-Flop (T-FF) from the right side becomes the most-significant bit. FIG. 6A shows the overall idea behind the proposed P2LSG. After grouping each bit from the counter, the inversion (via hardwiring) reverses the bit significance; the new binary output is ready for comparison in the SNG block. FIG. 6B illustrates examples of different bases.

FIG. 7 compares the hardware cost of generating Sobol and Halton sequences with that of the proposed sequence generator. We generate Halton #1 and Halton #2 using VDC-2 and VDC-3, respectively. In this case, the base-2 and base-3 counters are utilized to generate the Halton sequences. For P2LSG-4 and P2LSG-16, we employ VDC-4 and VDC-16, respectively. We note that any Powers-of-2 bases can be utilized to generate P2LSG sequences by a design similar to the design of FIG. 5 except with different hard-wiring schemes. We report the hardware area, power consumption, and critical path latency (CPL) for each case. We synthesized the designs using the Synopsys Design Compiler v2018.06 with the 45 nm FreePDK gate library. The reported numbers in FIG. 7 demonstrate that the proposed sequence generator surpasses the Sobol and Halton sequence generators in terms of hardware efficiency.

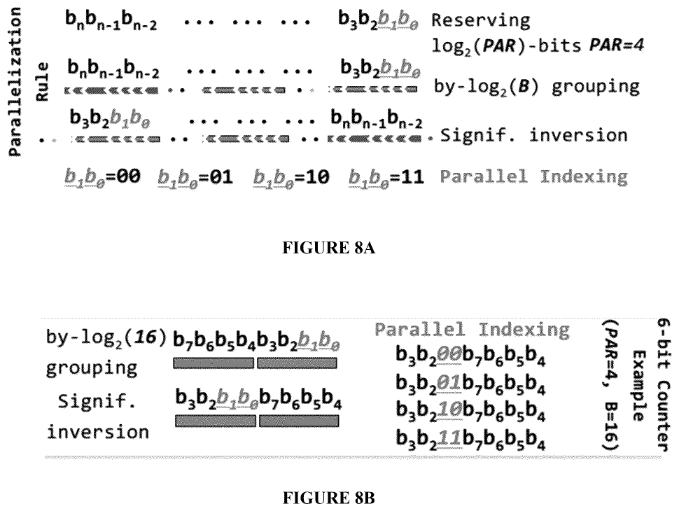

Parallel Design: The proposed Class-II P2LSG can also be generated in parallel. FIG. 8 illustrates how more than one number of a P2LSG sequence (in any base) can be generated in parallel at any cycle. Define PAR as the number of sequence elements to be generated in parallel. First, log2(PAR) bits are reserved at the least significant positions. The remaining bits require a reduced precision counter (e.g., 8→6 in FIG. 8). At any clock cycle, the reserved bits are filled with 2^{log}^{₂}^{PAR} possible logic values (parallel indexing). FIG. 8A shows an example for PAR=4. In this example, each output repeats four times to fill the reserved bits with 00, 01, 10, and 11. The outputs at any cycle produce four consecutive numbers. FIG. 8B illustrates another example of PAR=4 for P2LSG-16.

Performance Comparison of Different Sequences in SC. This section examines the use of the random sequences, comparing it to the newly disclosed P2LSG. We first analyze these sequences for basic SC operations and then extend the evaluations to more complex case studies. The numbers provided by these sequences are used as the required random numbers (R1. . . . RN) during bit-stream generation. Prior works used Sobol and Halton sequences for LD bit-stream generation. Here, the newly disclosed P2LSG provides an LD sequence generator based on the VDC Powers-of-2 bases (e.g., VDC-2, VDC-4, VDC-8, . . . , VDC-2^{m}m∈Z+) for cost-efficient LD bit-stream generation. The P2LSG is cost-(area and power) and energy-efficient for hardware implementation.

Benchmark-I: SC Multiplication. We first evaluate the performance of the selected sequences for 2-input SC multiplication. Two input values (X1 and X2) are converted to bit-stream representation using random sequences, and the generated bit-streams are bit-wise ANDed to produce the output bit-stream. The resulting bit-stream is converted back to standard representation (by counting the number of ‘1’s and dividing by the length of the bit-stream) and compared with the expected multiplication result to find the absolute error. Here, the expected value is P_{X1}×P_{X2}. For accurate multiplication, the input bit-streams must be uncorrelated. Stochastic Cross-Correlation (SCC) is used to quantify the correlation between bit-streams. In this metric, the correlation is calculated by using cumulative values denoted by a, b, c, and d, which depend on the counts of 11, 10, 01, or 00 pairs in the overlapping bits between the two bit-streams:

$$SCC = \{ \begin{matrix}\frac{ad - bc}{N \times min ( a + b , a + c ) - ( a + b ) \times ( a + c )} & , if ad > bc \\ \frac{ad - bc}{( a + b ) \times ( a + c ) - N \times max ( a - d , 0 )} & , else\end{matrix} \qquad ( 1 )$$

The multiplication accuracy for all Cartesian combinations X1 and X2 where the inputs are 8-bit precision values in the [0,1) interval

$$( i . e . , \frac{0}{256} , \frac{1}{256} , … , \frac{255}{256} )$$

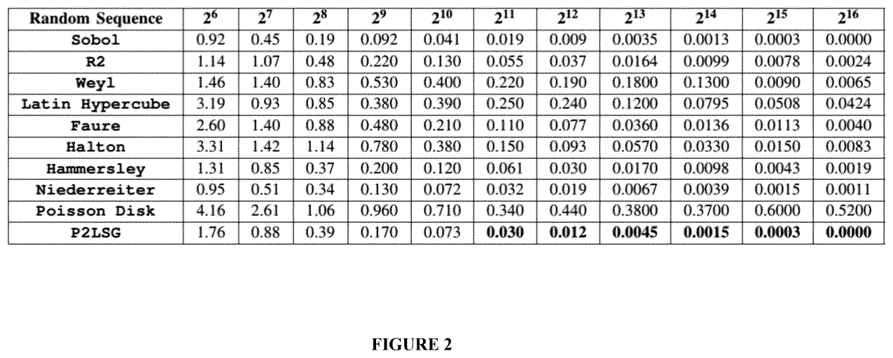

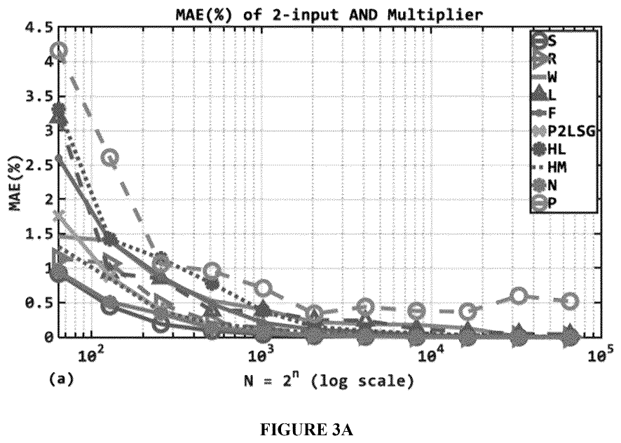

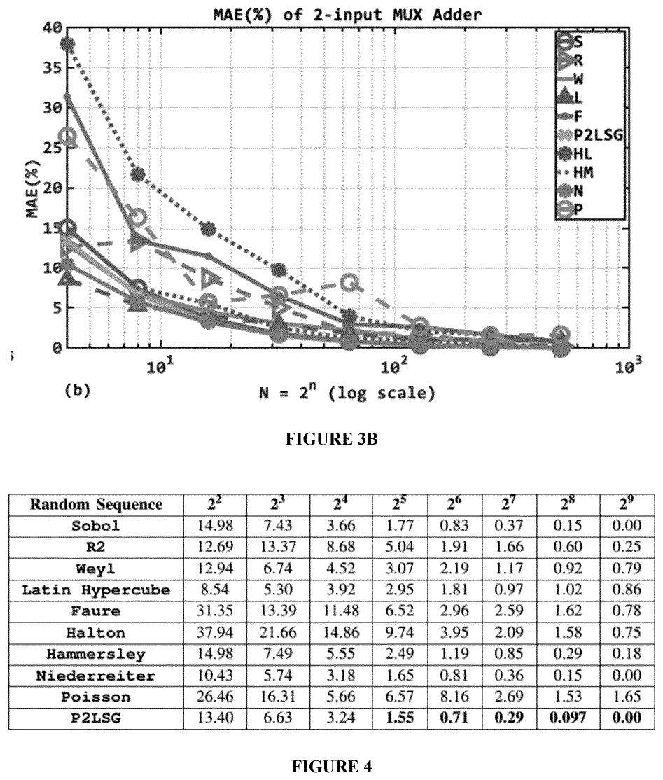

were extensively studied. The bit-stream lengths vary from 2⁶ to 2¹⁶ with 2× increments. FIG. 2 and FIG. 3A present the mean absolute error (MAE) of the multiplication results. We multiply the measured mean values by 100 and report them as percentages. Two different sequences are selected for each case to satisfy the uncorrelation requirement (SCC=0). For the Sobol sequence, the first two Sobol sequences from the MATLAB® built-in Sobol sequence generator are used. For the Faure sequence, two sequences are created using VDC-7.

The first dimension is generated using base-7, while the second is obtained through a permutation of the first one. The Halton sequence involves two dimensions generated using base-11 (VDC-11) and base-13 (VDC-13) with MATLAB® built-in Halton function. For the Hammersley sequence, we use the VDC-2 and VDC-3 sequences. The Latin Hypercube sequence was also generated using its MATLAB® built-in function. For the Weyl sequence, x and the Silver Ratio (i.e. \sqrt{2}−1) were chosen as the irrational numbers. The first dimension of our P2LSG sequence is VDC-2, while VDC-N is selected for the other dimensions depending on the bit-stream length (N). Moving from left to right in FIG. 2, the length of the bit-streams increases, and as expected, the accuracy improves (MAE decreases). Notably, the VDC-related sequences exhibit favorable convergence rates. Specifically, after 2¹⁰ operation cycles, the P2LSG sequence surpasses the Niederreiter sequence and approaches the Sobol sequence in terms of accuracy. For approximate results, the Sobol, Niederreiter, Hammersley, and P2LSG sequences emerge as the top performers. As can be seen in FIG. 3A, the convergence behavior of the P2LSG sequence outperforms other sequences as the length of the bit-stream increases.

Benchmark-II: SC Addition. Next, we evaluate the accuracy of the SC Scaled Addition. We utilize a 2-to-1 MUX with two 8-bit precision input operands similar to the multiplication operation. For this SC operation, the two addends (the main inputs of the MUX) are correlated (SCC=1), while the MUX select input is uncorrelated to the addends. To meet this requirement, we use a random sequence to generate the main input bit-streams and another sequence to generate the select bit-stream. For two-input addition, a bit-stream corresponding to 0.5 value is generated for the select input. FIG. 4 and FIG. 3B present the accuracy results in terms of MAE for different bit-stream lengths. Accurate output (0.0% MAE) can be achieved with a bit-stream length of 29 by using sequences such as Sobol, Niederreiter, Hammersley, and P2LSG. As can be seen in FIG. 4, for bit-stream sizes greater than 24, the P2LSG sequence achieves the minimum MAE among the other sequences. By increasing the bit-stream length (N), we can see that the MAE tends to zero for Sobol and P2LSG sequences.

Performance Evaluation. We further evaluate the performance and the hardware efficiency of the proposed P2LSG in two SC image and video processing case studies. Prior work used SC for low-cost implementation of different computer vision tasks from depth perception to interpolation. We first evaluate the proposed sequence generator in an interpolation and image scaling application and then study its effectiveness in a novel SC circuit for scene merging video processing, which we propose for the first time in the literature.

Interpolation and Image Scaling. Interpolation refers to the process of estimating or calculating values between two known data points. Linear interpolation is used to estimate values between two known values based on a linear relationship. It assumes a straight line between the available values and calculates intermediate values along that line. In image processing, linear interpolation is used to estimate pixel values between two neighboring pixels. Bilinear interpolation is a specific case of linear interpolation applied in two dimensions. Instead of estimating values along a straight line, it estimates values within a two-dimensional grid of pixels. It considers the four nearest pixels to the target location and calculates a weighted average of their values by using the distances between the target location and the surrounding pixels. This operation is used in image scaling tasks.

Assume an original image, I, with pixel values represented by a 2-D array. We want to estimate the pixel values at a non-integer coordinate (x,y) in the image. The four surrounding pixels to consider are (x₁, y₁), (x₁, y₂), (x₂, y₁), and (x₂, y₂), where (x₁, y₁) represents the pixel at the bottom-left corner of the target location, and (x₂, y₂) the pixel at the top-right corner. Let us denote the pixel values as I(x, y), I(x₁, y₁), I(x₁, y₂), I(x₂, y₁), and I(x₂, y₂). The bilinear interpolation formula is used to estimate the pixel value I(x, y) is as follows: I(x, y)=(1−u)(1−v)×I(x₁, y₁)+(1−u)v×I(x₁, y₂)+u(1−v)×I(x₂, y₁)+uv×I(x₂, y₂), where u=x−x₁ (fractional distance between x and x₁) and v=y−y₁ (fractional distance between y and y₁). The values (1−u)(1−v), (1−u) v, u(1−v), and uv are the weights assigned to each surrounding pixel. These weights represent the contribution of each pixel to the interpolated value. The interpolation formula can be compared to an SC MUX structure, where neighboring pixels are fed into the main MUX inputs, and the location information is fed into the selection ports. In this scenario, a 4-to-1 MUX can be expressed in terms of probabilities by P_{I(x,y)}=(1−Pᵤ)(1−Pᵥ)P_{I11}+(1−Pᵤ)(Pᵥ)P_{I12}+(Pᵤ)(1−Pᵥ) P_{I21}+(Pᵤ)(Pᵥ)P_{I22}.

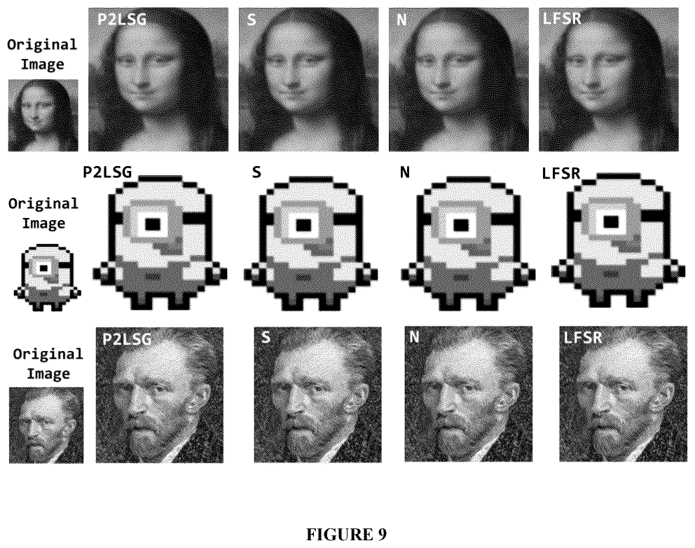

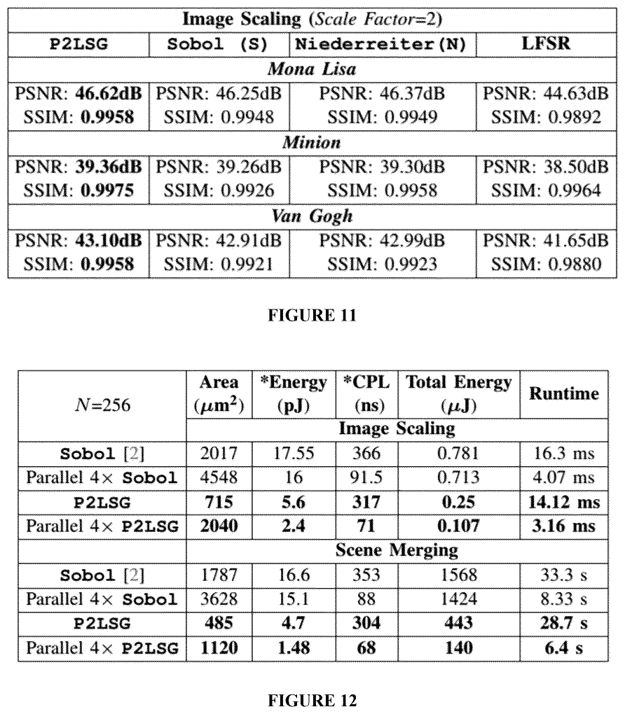

FIG. 9 visually demonstrates the outputs of 2× image scaling with an SC circuit composed of SNGs for data conversion and a 4-to-1 MUX unit. FIG. 11 presents the performance results in terms of peak signal-to-noise ratio (PSNR) and structural similarity (SSIM). We evaluated the SC circuit for the cases of using the P2LSG, Sobol(S), Niederreiter (N), and LFSR random sequences in the SNG units. We processed the Mona Lisa, Minion, and Van Gogh images as the test images. The results in FIG. 9 and FIG. 11 show the superior performance of the P2LSG sequences. We further evaluated the performance and energy consumption in 45 nm CMOS technology when processing the Mona Lisa image (107×104 image size) for the two cases of P2LSG and Sobol. FIG. 12 reports the results. The non-parallel and the 4× parallel designs of the P2LSG-based implementation save area by 65% and 55%, energy by 68% and 85%, and CPL by 13% and 22% compared to the non-parallel and 4× parallel Sobol-based implementation, respectively.

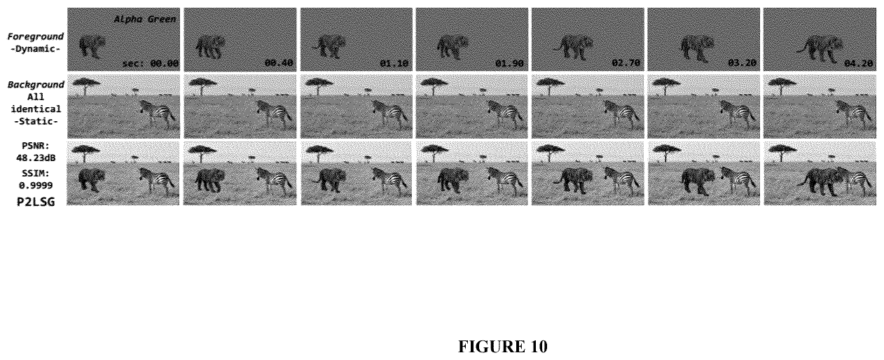

SC Video Processing: Scene Merging. As the second case study, we introduce an SC circuit for scene merging in video processing. The goal is to merge two different scenes in a video. One scene is a static image (background), while the other is a moving video sequence (foreground). To composite the images, the background image is processed with a transparent foreground image (green alpha channel) using the formula: Merged Pixel=Background Pixel×(1−alpha)+Foreground Pixel×alpha. Here, the alpha channel, which depends on the dynamic movement of the moving object in the green background, is updated frame by frame. Considering that the alpha value should be within the [0, 1] interval, the formula can be seen as a MUX with inputs being the foreground and background scenes and the selection port being the alpha channel: MUX=PX1 (1−PS)+PX2 PS, where PX1 and PX2 are the circuit inputs and PS is the select input. Based on this analogy, the video shown in FIG. 10, which features a moving tiger, is merged with an African jungle background. The video has a duration of 6.06 seconds and was generated at a frame rate of 30 frames per second. When using the P2LSG sequence for data conversion and a 2-to-1 MUX as the SC circuit, we achieved a PSNR of 48.23 dB and an SSIM of 0.999. We also achieved similar PSNR and SSIM values (48.13 dB and 0.9999) when using the Sobol-based SNG. However, as the hardware results presented in FIG. 12 demonstrate, the non-parallel and 4× parallel P2LSG design provides 73% and 69% lower area, 72% and 90% lower energy consumption, and 14% and 23% lower runtime compared to the non-parallel and 4× parallel Sobol-based design.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

We claim:

1. A sequence generator for use in a stochastic computing system comprising:
a processor;
a generated integer number comprising two or more bits;
a positive supply voltage;
a clock;
a plurality of base-B counters, wherein B refers to a count of the bits of the integer number;
a storage mechanism;
circuitry wiring connecting two or more outputs from the plurality of base-B counters to the storage mechanism, such that the bit order of the generated integer number may be stored in reverse bit significance order;
a plurality of adders;
a plurality of multiplexors; and
circuitry comprising functionality to perform shift operations.

2. The generator of claim 1, wherein for a base-10 integer number, the plurality of base-B counters comprises binary coded decimal counters.

3. A sequence generator for use in a stochastic computing system comprising:
a processor;
a generated integer number comprising two or more bits;
a positive supply voltage;
a clock;
a plurality of base-B counters, wherein B refers to a count of the bits of the integer number;
a storage mechanism;
a plurality of flip-flip gates; and
circuitry wiring connecting two or more outputs from the plurality of flip-flop gates to the storage mechanism, such that the bit order of the generated integer number may be stored in reversed bit significance order.

4. The generator of claim 3, wherein for a base-10 integer number, the plurality of base-B counters comprises binary coded decimal counters.

5. A method for generating Van der Corput sequences by a sequence generator in a stochastic computing system comprising:
(a) Generating an integer number, comprising groups of log₂(B) bits;
(b) Converting the integer number to a base-B representation;
(c) Storing the integer number in base-B representation;
(d) Reversing the base-B representation of the integer number;
(e) Converting the base-B representation to a binary number; and
(f) Scaling the binary number to a corresponding 8-bit binary number to be connected to a binary comparator.

6. The method of claim 5, wherein a base-B counter generates the integer number with a base-B representation.

7. The method of claim 5, wherein a binary coded decimal counter generates the integer number with a base-10 representation.

8. The method of claim 5, wherein the stored integer number in base-B representation is reversed through hard-wired mechanisms in the system.

9. The method of claim 5, wherein a binary counter generates the desired range of integer numbers.

10. The method of claim 5, further comprising to convert the value of a binary counter output to its base-B representation:
(a) Grouping the groups of log₂(B) bits, beginning with a least significant bit; and
(b) If a last group of log₂(B) bits contains insufficient bits, adding additional bits with a value of 0 to complete the group.

11. The method of claim 5, wherein the reversing operation is performed by hard-wiring each group of bits, treating each group of log₂(B) bits as a single digit in the base-B representation.

12. The method of claim 5, wherein converting the base-B representation to an equivalent binary representation comprises:
establishing each group of converted log₂(B) bits as an equivalent log₂(B) bits of binary representation; and
discarding any bits that exceed the count of log₂(B) bits in Step (a).

13. The method of claim 5, wherein, where multiple integer numbers are to be generated, the method is executed in parallel.
